(19) United States
(12) Patent Application Publication
(10) Pub. No.: US 2020/0209344 A1
(43) Pub. Date: Jul. 2, 2020

(54) OBJECT DETECTION VIA BLUETOOTH LOW ENERGY

(71) Applicant: Continental Automotive Systems, Inc., Auburn Hills, MI (US)

(72) Inventors: Aaron Adler, Rochester Hills, MI (US); Djordje Preradovic, Shelby Township, MI (US)

(21) Appl. No.: 16/411,190

(22) Filed: May 14, 2019

Related U.S. Application Data
(60) Provisional application No. 62/785,410, filed on Dec. 27, 2018.

(51) Int. Cl. G01S 5/14; H04B 1/3822; H04W 4/80

(52) U.S. Cl. CPC G01S 5/14; H04W 4/80; H04B 1/3822

(57) ABSTRACT

A vehicle object detection system according to an example of the present disclosure at least two BLE modules configured to communicate with each other and measure RSSI values between the at least two BLE modules. The system also includes a main controller configured to communicate with the at least two BLE modules to receive the measured RSSI values between the at least two BLE modules. At least one of the main controller or at least one of the at least two BLE modules are configured to evaluate said measured RSSI values to detect an object between the at least two BLE modules in response to a change in said measured RSSI values.

### PRIORITY CLAIM

This application claims priority to provisional application No. 62/785,410 filed Dec. 27, 2018, the entirety of which is hereby incorporated by reference.

### BACKGROUND

Bluetooth systems may have use in a variety of applications. These systems must be reliable and efficiently meet the needs of users.

Vehicles employ Bluetooth systems to connect user's electronic devices with the vehicle. Such systems are becoming more prevalent in vehicles. Such systems would be aided by accurate detection of objects in the vehicle.

### SUMMARY

An object detection system according to an example of the present disclosure includes at least two Bluetooth Low Energy (“BLE”) modules configured to communicate with each other and measure Received Signal Strength Indicator (“RSSI”) values between the at least two BLE modules. The system also includes a main controller configured to communicate with the at least two BLE modules to receive the measured RSSI values between the at least two BLE modules. At least one of the main controller or at least one of the at least two BLE modules are configured to evaluate said measured RSSI values to detect an object between the at least two BLE modules in response to a change in said measured RSSI values.

A vehicle object detection system according to an example of the present disclosure at least two BLE modules configured to communicate with each other and measure RSSI values between the at least two BLE modules. The system also includes a main controller configured to communicate with the at least two BLE modules to receive the measured RSSI values between the at least two BLE modules. At least one of the main controller or at least one of the at least two BLE modules are configured to evaluate said measured RSSI values to detect an object between the at least two BLE modules in response to a change in said measured RSSI values.

A method of detecting objects in a vehicle according to an example of the present disclosure includes providing at least two BLE modules configured to communicate with each other. A RSSI value is measured between the at least two BLE modules. The measured RSSI is communicated to a main controller. The measured RSSI value is evaluated using at least one of the main controller or at least one of the at least two BLE modules to determine whether an object is present between the at least two BLE modules in response to a change in said measured RSSI value.

### BRIEF DESCRIPTION OF THE DRAWINGS

FIG. 1 schematically shows an example object detection system in a vehicle.

FIG. 2 schematically shows an example object detection system in a vehicle with an object in the vehicle.

FIG. 3 schematically shows an example BLE module.

FIG. 4 schematically shows an example main controller.

FIG. 5 schematically shows an example BLE transceiver.

### DETAILED DESCRIPTION

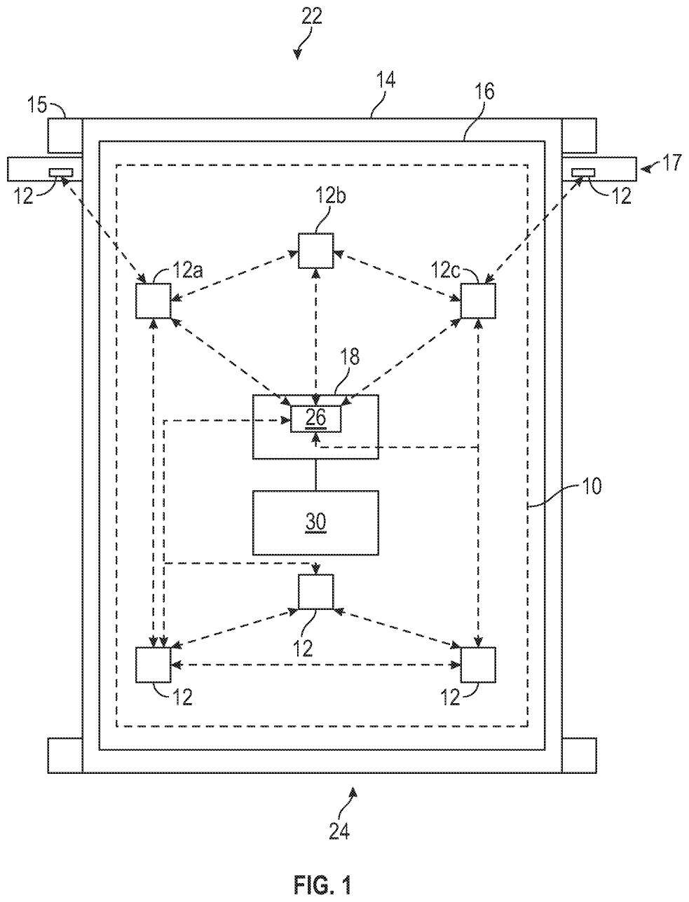

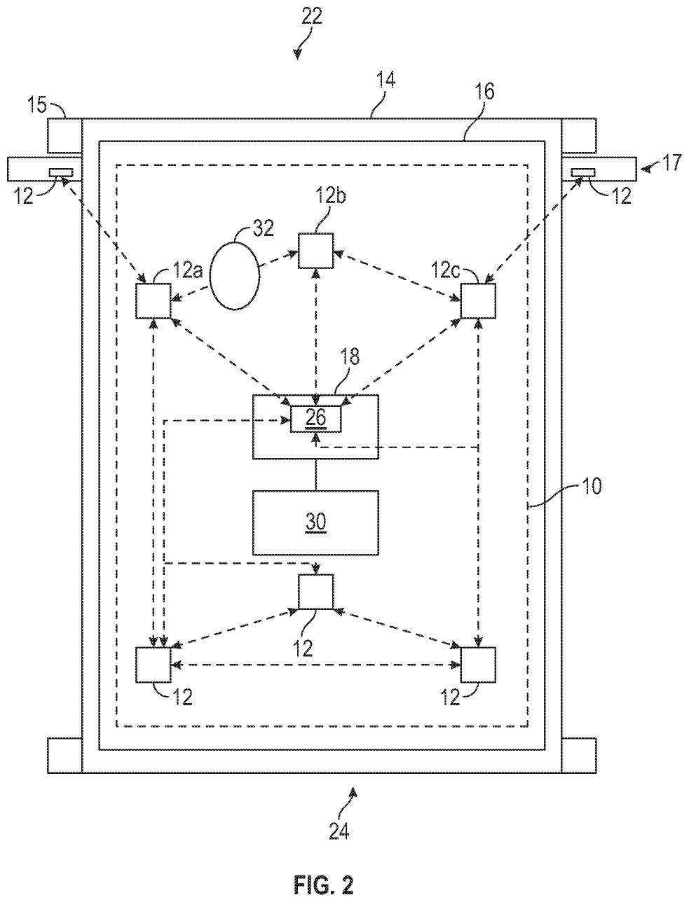

FIGS. 1-5 schematically shows an object detection system 10 including at least two Bluetooth Low Energy (“BLE”) module 12. Referring to FIGS. 1 and 2, the object detection system 10 may be used for a number of applications such as automotive vehicles, retail, and manufacturing. FIG. 2 further indicates an object 32, such as a person, that is being detected between two BLE modules 12, as will be discussed further herein.

In one example, a vehicle 14 having wheels 15, front end 22, and rear end 24 includes the object detection system 10 with at least two BLE module 12. In this example, the object detection occurs using the at least two BLE module 12. At least two BLE modules 12 includes a first BLE module 12a, second BLE module 12b, and third BLE module 12c. The BLE modules 12a, 12b, 12c are located inside the interior cabin 16 of the vehicle 14. In this example, BLE module 12a is generally located in a left, front half of the interior cabin 16, BLE module 12b is generally located in the center, front half of the interior cabin 16, and BLE module 12c is generally located in the center, right half of the interior cabin 16. Additional BLE modules 12 may be located in the interior cabin 16, or outside the interior cabin 16, in a variety of locations as necessary depending on the design parameters of the vehicle 14. In one example, one or more BLE modules 12 are located in a mirror 17 of the vehicle 14. Other locations outside of the interior cabin 16 may be used.

In one example, the BLE modules 12a, 12b, 12c located inside the interior cabin 16 are in communication with each other via BLE. When the BLE modules 12a, 12b, 12c communicate with each other, the BLE modules 12a, 12b, 12c are measuring received signal strength indicator (“RSSI”) values from each other. The RSSI provides a value of radio frequency (“RF”) power received at a BLE module 12a, 12b, 12c. For example, when BLE module 12a communicates with BLE module 12b, BLE module 12b is measuring the RSSI value of the signal received from BLE module 12a, and vice versa. Each BLE module 12 may be in communication with multiple additional BLE modules 12 including up to all of the BLE modules 12 of the object detection system 10. Through BLE, the BLE modules 12 are connected and communicate bi-directionally and wirelessly.

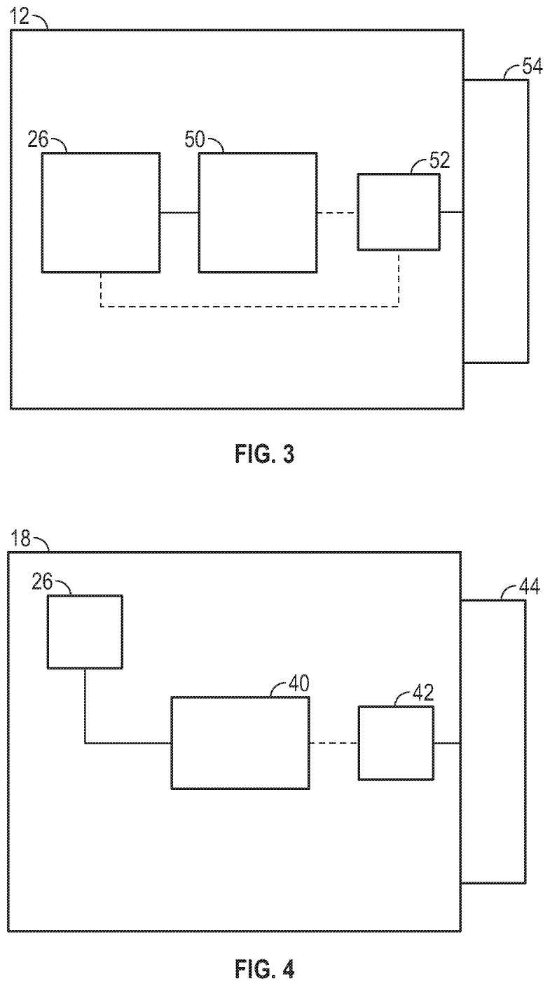

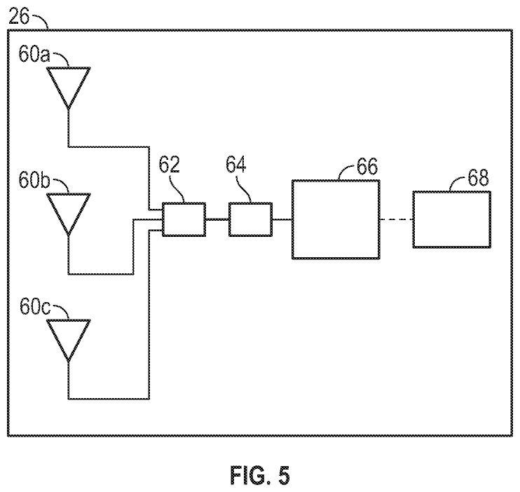

Referring to FIG. 3, with continued reference to FIGS. 1-2, an example BLE module 12 includes a BLE transceiver 26, a link 52, and a connector 54. The BLE transceiver 26 is described in further detail herein. The BLE transceiver 26 is in communication with link 52. Link 52 may operate through a controller area network (“CAN”), a local interconnect network (“LIN”), or a Universal Asynchronous Receiver/Transmitter (“UART”). Link 52 connects to the vehicle 14 LIN or CAN, or communicates through the UART, via connector 54. Connector 54 provides an external connection for connection to other systems or components. BLE transceiver 26 communicates with link 52 via an UART or a Serial Peripheral Interface (“SPI”). In this manner, the BLE module 12 communicates with the main controller 18, the vehicle 14, vehicle control system 30, and/or other vehicle systems. In one example, the BLE transceiver 26 communicates with a microcontroller 50 for the BLE module 12. The microcontroller 50 then communicates to the link 52 to provide data and information including RSSI values. In one example, the BLE transceiver 26 does not have an integrated circuit (shown in FIG. 5) resulting in the use of microcontroller 50. In another example, the integrated circuit of the BLE transceiver 26 and the microcontroller 50 are both used.

Referring to FIG. 4, with continued reference to FIGS. 1-2, an example main controller 18 includes a BLE transceiver 26, a microcontroller 40, a link 42, and a connector 44. The BLE transceiver 26 is described in further detail herein. The BLE transceiver 26 is in communication with microcontroller 40 via an UART or a SPI. Microcontroller 40 processes RSSI values, and in some instances additional information, to use the RSSI values as described in this disclosure. Moreover, microcontroller 40 runs a localization algorithm that may use measured RSSI values to assist other vehicle systems and functions. Microcontroller 40 communicates with link 42, which may operate through a CAN or LIN. Link 42 connects to the vehicle LIN or CAN via connector 44. In this manner, the main controller 18 communicates with the vehicle 14, vehicle control system 30, and/or other vehicle systems.

Main controller 18 includes the BLE transceiver 26 that communicates with BLE modules 12 and can receive measured RSSI values between BLE modules 12. A BLE transceiver 26 is also present in each BLE module 12. Main controller 18 may be connected to and communicate with a vehicle control system 30 via BLE, a link to a CAN, or a link to a LIN. The main controller 18 uses a localization algorithm to determine whether objects have been detected and, in certain circumstances, the type of object.

In one example, the detection of an object 32 is used in conjunction with the localization algorithm to calibrate the localization algorithm when other objects 32, or persons, are detected in the vehicle. For example, the main controller 18 can receive all of the measured RSSI values from each BLE module 12. Microcontroller 40 of main controller 18 uses the measured RSSI values to determine the position of persons that may have a BLE device, such as a cellphone or key fob, by using and applying the localization algorithm. In response to the measured RSSI values, the main controller 18 can also control other vehicle 14 systems including vehicle door locks, windows, alarms, remote start, rain sensors, interior lighting, rear brake lighting, or other vehicle 14 features.

Referring to FIG. 5, with continued reference to FIGS. 1-2, an example BLE transceiver 26 includes antennas 60a, 60b, 60c, an RF switch 62, an RF Filter 64, an integrated circuit, or chip, 66, and a link 68. Antennas 60a, 60b, 60c receive or transmit information for the BLE transceiver 26, including measured RSSI values and data. Although three antennas 60a, 60b, 60c are shown, more or fewer antennas 60a, 60b, 60c may be used. Antennas 60a, 60b, 60c communicate with the integrated circuit 66 through RF switch 62 and RF filter 64. RF switch controls which antennas 60a, 60b, 60c are used in a given time period. RF filter 64 reduces noise in the transmitted data. Integrated circuit 66 controls the transmission and receipt of RSSI values for the BLE transceiver 26. The integrated circuit 66 also communicates measured RSSI values, or other RSSI information, from the BLE transceiver 26 to another component, such as main controller 18, through link 68. Link 68 allows BLE transceiver 26 to communicate with other components via an UART or a SPI.

Referring to FIGS. 1-6, in one example the RSSI values measured during communication between BLE modules 12 are evaluated and processed on the corresponding BLE module 12. Each BLE module 12 compares the RSSI values being received to other RSSI values to determine changes in RSSI values. In one example, these RSSI values are communicated to each BLE module 12 automatically. In one example, the measured RSSI values are compared to a pre-determined threshold RSSI value, as described in further detail below.

In another example, the RSSI values measured during communication between BLE modules 12 are sent to the main controller 18 for evaluation and processing. In this example, the BLE modules 12 communicate with the main controller using BLE, a CAN, or a LIN. However, other methods of communication with the main controller 18 are within the contemplation of this disclosure. In one example, the measured RSSI values are communicated from each BLE module 12 automatically. In one example, the measured RSSI values are compared to a pre-determined threshold RSSI value, as described in further detail below.

In one example, when a user approaches the vehicle 14 the main controller 18 and BLE modules 12 are calibrated to provide a present baseline RSSI value. Calibrating the BLE modules 12 baseline RSSI values allows for any environmental or vehicle factors that may affect object detection by the object detection system 10. The BLE modules 12 are able to determine a baseline RSSI value where no object is detected in any environment so that object detection accuracy is enhanced. After the baseline RSSI value is determined, the BLE modules 12 and/or main controller 18 will communicate periodically to determine RSSI values. In one example, the BLE modules 12 and/or main controller 18 communicate on pre-determined time intervals. In one example, the BLE modules are calibrated before being used in the object detection system 10 based on an expected RSSI value corresponding to no object being detected.

Pre-determined thresholds can be established corresponding to the detection of certain objects 32. Specifically, for example, a pre-determined RSSI value or pre-determined drop in RSSI value may correlate to the presence of a person between two BLE modules 12. Another pre-determined RSSI value or pre-determined drop in RSSI value may correlate to a metal object between two BLE modules 12. Pre-determined RSSI values or changes in RSSI value can be used to correspond to particular objects 32, allowing the main controller 18 and vehicle control system 30 to provide and use that information as necessary for other vehicle systems and features. Moreover, the main controller 18 using data in a localization algorithm can tailor the data being provided. For example, if it is desired to identify only persons being located in the vehicle 14, then RSSI values or changes in RSSI values correlating to other objects can be excluded from the localization algorithm. The main controller 18 may also communicate with other systems or components, as necessary, based on the evaluation of measured RSSI values and the localization algorithm.

In one example, the object detection system 10 is able to determine the location of a person in the vehicle 14. The vehicle control system 30 is provided this information and can use this location data, as necessary, to enhance other vehicle system features or systems.

In one example use, when a user approaches the vehicle 14, the vehicle 14 through the object detection system 10 will calibrate the BLE modules 12 to obtain static, baseline RSSI values, as discussed herein. In use, when there is an object 32 between two BLE modules 12, such as BLE modules 12a, 12b, that are communicating in the vehicle 14, there will be a resulting drop in RSSI values measured between the two BLE modules 12a, 12b. When such drop in RSSI values is detected, indicating an object 32 is present between the BLE modules 12a, 12b, this data will be provided to the main controller 18 and added to the localization algorithm by the main controller 18 for the use in the vehicle 14.

In one example, the object detection system 10 detects different objects 32 by determining RSSI values or changes in RSSI values and comparing these RSSI values to predetermined thresholds for the expected change in, or corresponding, RSSI values. In one example, the object detection system 10 is set to detect only persons. In this example, when a predetermined RSSI value corresponds to the detected object 32 being a human user, the main controller 18 provides the data to the localization algorithm. If a different value is detected, the main controller 18 withholds that data from the localization algorithm.

In one example, the object detection system 10 is calibrated to address the circumstance of objects 32 being placed inside the vehicle 14 when it is parked. The object detection system 10 also increases accuracy of detection of other electronic devices or systems at least in part by determining what location of the vehicle 14 the user may be positioned in (for example, driver seat, passenger seat, rear seats of the vehicle 14).

In one example, the detection of an object 32 is used in conjunction with various vehicle 14 systems. In one example, the main controller 18 or vehicle control system 30 communicates other vehicle 14 systems to enable or disable vehicle 14 airbags, adjust seat positions, or adjust mirror 17 positions. In one example, the main controller 18 or vehicle control system 30 communicates other vehicle 14 systems to enable a security warning if an unauthorized object 32 is detected inside the vehicle 14. In this example, the security warning may be enabled if the localization algorithm indicates an expected user is outside the vehicle 14.

In one example, detection of a change in measured RSSI values between two BLE modules 12 may be used as a diagnostic feature to determine whether the BLE transceiver 26 is damaged. In this example, RSSI values are measured continuously without an object 32 in the vehicle. Measured RSSI values less than the expected, predetermined value result in detection of either a permanent obstruction between the BLE modules 12 or a damaged BLE module 12. The main controller 18 may relay a warning signal or other indicator upon making or receiving such a determination.

In one example, two or more object detection systems 10 including any of the features herein may be within communication range of one another. The main controllers 18 and BLE modules 12 of the two or more object detection systems 10 communicate with each other. In this example, a calibration sequence to determine a baseline RSSI value occurs. RSSI values can be compared and measured between a BLE module 12 in the first object detection system 10 and a BLE module 12 in the second object detection system 10. The first and second object detection systems 10 can then detect an object 32 between them that is indicated by a change in measured RSSI values, as explained herein. In one example, a first vehicle 14 and second vehicle 14 may be parked next to each other such that their respective object detection systems 10 communicate to detect objects 32 between the vehicles 14.

In one example, external vehicle cameras can be activated to record in response to detection of an object between the two vehicles 14. In another example, the vehicle 14 user can be alerted to the presence of an unauthorized object 32 close to the vehicle 14 in response to detection of an object between the two vehicles 14. In one example, the vehicle 14 can be woken from a low power state or activate increased security programs or systems in response to detection of an object 32 between the two vehicles 14.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle object detection system comprising:
at least two BLE modules configured to communicate with each other and measure RSSI values between the at least two BLE modules; and
a main controller configured to communicate with the at least two BLE modules to receive the measured RSSI values between the at least two BLE modules, wherein at least one of the main controller or at least one of the at least two BLE modules are configured to evaluate said measured RSSI values to detect an object between the at least two BLE modules in response to a change in said measured RSSI values.

2. The vehicle object detection system of claim 1, wherein the at least two BLE modules are located within a vehicle.

3. The vehicle object detection system of claim 1, wherein the main controller is configured to communicate with at least one of a safety system, remote start system, seat adjustment system or security system of a vehicle in response to detection of the object.

4. The vehicle object detection system of claim 1, wherein each BLE module includes a BLE transceiver configured to communicate with the main controller.

5. The vehicle object detection system of claim 1, wherein the at least two BLE modules includes a first BLE module configured to communicate with a second BLE module to measure a first measured RSSI value between the first BLE module and the second BLE module, wherein at least one of the first BLE module, the second BLE module, or the main controller compares the first measured RSSI value to a predetermined RSSI value to determine the presence of an object between the first BLE module and the second BLE module.

6. The vehicle object detection system of claim 5, including a third BLE module configured to communicate with the first BLE module and the second BLE module to measure at least one additional measured RSSI value.

7. The vehicle object detection system of claim 5, wherein the predetermined RSSI value corresponds to the presence of a person between the first BLE module and the second BLE module.

8. The vehicle object detection system of claim 1, wherein the at least two BLE modules are calibrated to provide a baseline RSSI value corresponding to no object being detected, wherein at least one of the main controller or at least one of the at least two BLE modules are configured to compare the measured RSSI values to the baseline RSSI value to detect the object.

9. The vehicle object detection system of claim 1, wherein the at least two BLE modules are configured to communicate the measured RSSI values to the main controller on pre-determined time intervals.

10. The vehicle object detection system of claim 1, wherein the main controller is configured to provide data to a localization algorithm based on what objects are to be detected.

11. The vehicle object detection system of claim 1, wherein the main controller is configured to communicate with the at least two BLE modules through a CAN or LIN connection.

12. The vehicle object detection system of claim 1, wherein at least one of the at least two BLE modules is outside of a vehicle.

13. The vehicle object detection system of claim 1, wherein the main controller communicates with a vehicle system through at least one of a LIN or a CAN.

14. The vehicle object detection system of claim 1, wherein the at least two BLE modules each include a BLE transceiver, a microcontroller, and a link, wherein the at least two BLE modules are configured to evaluate said measured RSSI values to detect an object between the at least two BLE modules in response to a change in said measured RSSI values.

15. The vehicle object detection system of claim 1, wherein the change in measured RSSI value is a drop in RSSI value that indicates the presence of the object.

16. A method of detecting objects in a vehicle comprising:
providing at least two BLE modules configured to communicate with each other;
measuring a RSSI value between the at least two BLE modules on at least one of the at least two BLE modules;
communicating the measured RSSI value to a main controller;
evaluating the measured RSSI value using at least one of the main controller or at least one of the at least two BLE modules to determine whether an object is present between the at least two BLE modules in response to a change in said measured RSSI value.

17. The method of claim 16, wherein the at least two BLE modules are located within a vehicle.

18. The method of claim 16, further including the step of communicating the measured RSSI values to the main controller on pre-determined time intervals using the at least two BLE modules.

19. The method of claim 16, further including the step of calibrating the at least two BLE modules to provide a baseline RSSI value corresponding to no object being detected; and comparing the measured RSSI values to the baseline RSSI value to detect the object.

20. The method of claim 16, further including the step of comparing the first measured RSSI value to a predetermined RSSI value using the main controller to determine the presence of an object between the first BLE module and the second BLE module.
